(19) United States
(12) Patent Application Publication
(10) Pub. No.: US 2015/0227955 A1
(43) Pub. Date: Aug. 13, 2015

(54) SHOPPING E-MONEY MANAGEMENT SERVICE METHOD IN ELECTRONIC COMMERCE USING INTERNET AND COMPUTER-READABLE RECORDING MEDIUM HAVING PROGRAM RECORDED THEREON FOR EXECUTING SAME

(71) Applicant: EBAY KOREA CO., LTD., SEOUL (KR)

(72) Inventor: Kyoung Jun Lee, Nowon-gu (KR)

(21) Appl. No.: 14/423,068

(22) PCT Filed: Nov. 8, 2012
(86) PCT No.: PCT/KR2012/009370

§ 371 Date: Feb. 20, 2015

(30) Foreign Application Priority Data
Aug. 21, 2012 (KR) 10-2012-0091329

(51) Int. Cl. G06Q 30/02

(52) U.S. Cl. CPC G06Q 30/0215; G06Q 30/0224; G06Q 30/0236

(57) ABSTRACT

The present invention relates to a shopping e-money management service method in an electronic commerce using the internet, wherein the shopping e-money is provided to a newly registered member or a product non-shopper who does not have a product purchase list for a certain period of time such that the member or the non-shopper can use a fixed amount of money like cash for a monthly installment, thereby enabling cost efficiency and inducing continuous purchases.

### TECHNICAL FIELD

The present invention relates to a shopping e-money management service method in electronic commerce using the Internet, and more particularly, to a shopping e-money management service method in electronic commerce using the Internet in which a fixed amount of shopping e-money is provided over a plurality of months to a newly registered member or a product non-purchasing member who has not purchased a product for a certain period of time such that the new member or the non-purchasing member can use the shopping e-money like cash, thereby improving cost efficiency and inducing continuous purchases, and a computer-readable recording medium storing a program for executing the same.

### BACKGROUND ART

Recently, with the rapid growth of the Internet, the use of electronic commerce of purchasing products online is increasing day by day. Such electronic commerce is extending up to various products including daily supplies, household items, electronics, and so on.

Such development of electronic commerce owes much not only to the development of communication networks but also to new benefits of sellers and purchasers that cannot be obtained in a traditional commerce system.

In other words, sellers cut down facility cost, which can be reflected in the prices of product, because it is unnecessary for the sellers to own stores and separate large warehouses for storing products. Not only can purchasers conveniently do shopping without inconvenient visits to stores, but they can also purchase products at lower prices.

Even in a product purchasing process based on such electronic commerce, like in offline commerce, cyber customers want a payment system in which it is possible to get various discount benefits, such as discount coupons, for increasing the motivation of purchase.

### DISCLOSURE

### Technical Problem

The present invention is directed to providing a shopping e-money management service method in electronic commerce using the Internet, and more particularly, to providing a shopping e-money management service method in electronic commerce using the Internet in which a fixed amount of shopping e-money is provided over a plurality of months to a newly registered member or a product non-purchasing member who has not purchased a product for a certain period of time such that the new member or the non-purchasing member can use the shopping e-money like cash, thereby improving cost efficiency and inducing continuous purchases, and a computer-readable recording medium storing a program for executing the same.

### Technical Solution

One aspect of the present invention provides a shopping e-money management service method in electronic commerce using the Internet in an electronic commerce method for relaying an online transaction when a purchaser purchases a product from an online shopping mall including a purchaser terminal connected to a shopping mall server via the Internet, the shopping e-money management service method including: (a) setting, by the shopping mall server, total amounts of shopping e-money to be provided and total numbers of months of installment payment according to shopping e-money provision target members; (b) when member login input data is provided from the purchaser terminal, determining, by the shopping mall server, whether a corresponding login member is included in the shopping e-money provision target members set in step (a); and (c) when it is determined in step (b) that the corresponding login member is included in the shopping e-money provision target members set in step (a), providing, by the shopping mall server, shopping e-money, which can be used to purchase products, to the corresponding login member over a plurality of months according to a shopping e-money provision target member set in step (a).

Preferably, step (a) may include selecting, by the shopping mall server, a method of providing the total amounts of shopping e-money to be provided in equal monthly installments or a method of providing the total amounts of shopping e-money to be provided in unequal monthly installments.

Preferably, step (a) may include setting members who newly registered with the shopping mall server or product non-purchasing members who have not purchased a product for a certain period of time among existing registered members as the shopping e-money provision target members.

Preferably, step (a) may include differentially setting, by the shopping mall server, the total amounts of shopping e-money to be provided according to the shopping e-money provision target members.

Preferably, step (c) may include, when the corresponding login member is included in the shopping e-money provision target members set in step (a), providing, by the shopping mall server, service such that current status of use of provided shopping e-money is displayed on a screen of the purchaser terminal.

Preferably, the shopping e-money management service method may further include, after step (c), monitoring, by the shopping mall server, shopping e-money provided to respective members, and stopping provision of shopping e-money when shopping e-money provided in a first month is not used.

Preferably, the shopping e-money management service method may further include, after step (c), storing and managing, by the shopping mall server, the total amounts of shopping e-money to be provided, the total numbers of months of installment payment, and amounts of e-money to be provided every month according to the shopping e-money provision target members as a database (DB).

Another aspect of the present invention provides a computer-readable recording medium storing a program for executing the above-described shopping e-money management service method in electronic commerce using the Internet.

The shopping e-money management service method in electronic commerce using the Internet can be implemented as computer-readable code in computer-readable recording media. The computer-readable recording media include all types of recording devices for storing data that can be read by a computer system.

For example, the computer-readable recording media include a read only memory (ROM), a random access memory (RAM), a compact disc (CD)-ROM, a magnetic tape, a hard disk, a floppy disk, a portable storage device, a non-volatile memory (flash memory), an optical data storage device, and so on.

### Advantageous Effects

According to the above-described shopping e-money management service method of the present invention in electronic commerce using the Internet and the above-described computer-readable recording medium storing a program for executing the same, a fixed amount of shopping e-money is provided over a plurality of months to a newly registered member or a product non-purchasing member who has not purchased a product for a certain period of time such that the new member or the non-purchasing member can use the shopping e-money like cash. Therefore, a total amount of e-money to be provided is emphasized to attract attention and provided over a plurality of months to improve cost efficiency, and also the motivation of purchase is increased to induce continuous purchases rather than a temporary purchase.

### DESCRIPTION OF DRAWINGS

FIG. 1 is an overall block diagram of a system for implementing a shopping e-money management service method in electronic commerce using the Internet according to an exemplary embodiment of the present invention.

FIG. 2 is an overall flowchart illustrating a shopping e-money management service method in electronic commerce using the Internet according to an exemplary embodiment of the present invention.

FIGS. 3 to 8 are example diagrams of a screen illustrating a shopping e-money management service method in electronic commerce using the Internet according to an exemplary embodiment of the present invention.

### MODES OF THE INVENTION

Hereinafter, exemplary embodiments of the present invention will be described in detail with reference to the accompanying drawings. However, exemplary embodiments of the present invention shown as examples below can be modified in various other forms, and the scope of the present invention is not limited to the exemplary embodiments described below. The exemplary embodiments of the present invention are provided to fully describe the present invention to those of ordinary skill in the art.

As used herein, the term “shopping e-money (or Sehal money)” indicates electronic money that can be used like cash to purchase a product from an online shopping mall, and denotes a discount benefit like golden eggs, that is, shopping e-money which is provided at one time and can be used like cash equally or differentially over a certain number of months.

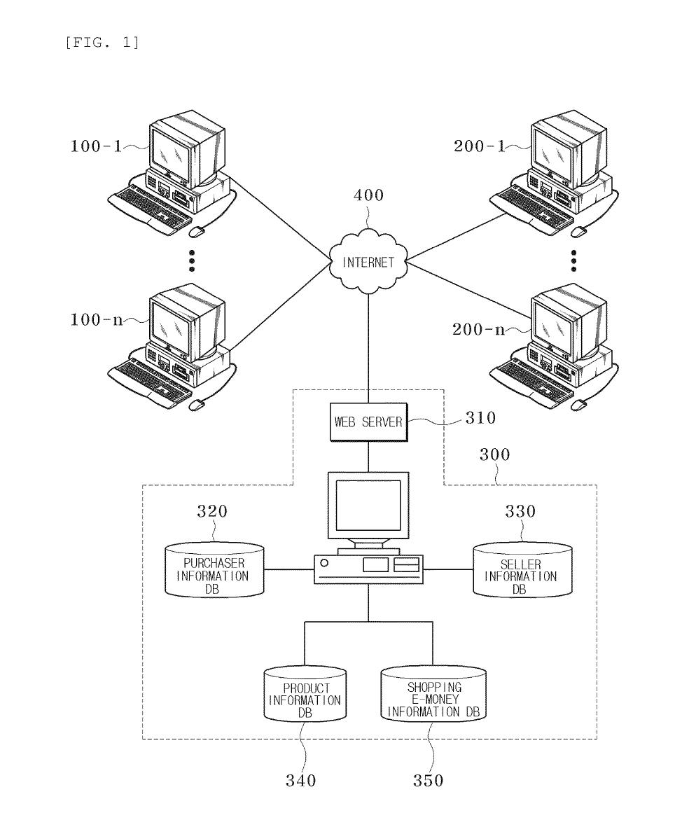

FIG. 1 is an overall block diagram of a system for implementing a shopping e-money management service method in electronic commerce using the Internet according to an exemplary embodiment of the present invention.

Referring to FIG. 1, an overall system for implementing a shopping e-money management service method in electronic commerce using the Internet according to an exemplary embodiment of the present invention generally includes at least one purchaser terminal 100-1 to 100-n, at least one seller terminal 200-1 to 200-n, an online shopping mall server 300, a web server 310, a purchaser information database (DB) 320, a seller information DB 330, a product information DB 340, a shopping e-money information DB 350, and so on.

Here, the at least one purchaser terminal 100-1 to 100-n and the at least one seller terminal 200-1 to 200-n are connected to the online shopping mall server 300 via the Internet 400.

Here, the Internet 400 denotes an open global computer network structure that provides transmission control protocol/Internet protocol (TCP/IP) and various services on an upper layer of TCP/IP, that is, hypertext transfer protocol (HTTP), telnet, file transfer protocol (FTP) service, domain name system (DNS), simple mail transfer protocol (SMTP), simple network management protocol (SNMP), network file service (NFS), network information service (NIS), etc., and provides an environment in which an arbitrary purchaser and seller of the purchaser terminal 100-1 to 100-n and the seller terminal 200-1 to 200-n can be connected to the online shopping mall server 300 to be described below. The Internet 400 may be wired or wireless Internet, or a core network integrated with a wired public network, a wireless mobile communication network, portable Internet, or so on.

Meanwhile, the purchaser terminal 100-1 to 100-n and the seller terminal 200-1 to 200-n are generally, for example, computers such as a desktop personal computer (PC) and a laptop PC. However, the purchaser terminal 100-1 to 100-n and the seller terminal 200-1 to 200-n are not limited to the computers and may be all types of wired and wireless communication devices that connect to the online shopping mall server 300 via the Internet 400 and can use a bidirectional electronic commerce service.

For example, the purchaser terminal 100-1 to 100-n and the seller terminal 200-1 to 200-n include mobile terminals communicating via wireless Internet or portable Internet, such as a cellular phone, a personal communications services phone (PCS) phone, and a synchronous/asynchronous international mobile telecommunication (IMT)-2000. In addition to these, the purchaser terminal 100-1 to 100-n and the seller terminal 200-1 to 200-n can comprehensively include all wired and wireless home appliances/communication devices having user interfaces for connecting to the online shopping mall server 300, such as a palm PC, a personal digital assistant (PDA), a smart phone, a wireless application protocol (WAP) phone, and a mobile gaming machine (mobile play-station).

Such a purchaser terminal 100-1 to 100-n can connect to the online shopping mall server 300 via the Internet 400, and use a transaction relay service of the online shopping mall server 300 for products, various services, etc. according to wired and wireless communication processing by a communication interface. A purchaser can subscribe as a customer who uses a service of the online shopping mall server 300 using the purchaser terminal 100-1 to 100-n, and purchaser information, etc. registered by the subscribed purchaser can be stored in the purchaser information DB 320.

The seller terminal 200-1 to 200-n also can connect to the online shopping mall server 300 via the Internet 400, and use the transaction relay service of the online shopping mall server 300 for products, services, etc. according to wired and wireless communication processing by a communication interface. A seller can subscribe as a customer who uses a service of the online shopping mall server 300 using the seller terminal 200-1 to 200-n, and seller information, product information, etc. registered by the subscribed seller can be stored in the seller information DB 330.

The seller terminal 200-1 to 200-n registers various sale products offered for sale by sellers in the online shopping mall server 300 that runs an online shopping mall via the Internet 400 to relay product transactions between sellers and purchasers, via the Internet 400, and the online shopping mall server 300 manages a web page, which is needed to run the shopping mall, to provide the registered various sale products to the purchaser terminal 100-1 to 100-n through the web server 310 connected to the Internet 400 such that purchasers can purchase needed sale products.

Also, the online shopping mall server 300 can process payment for a sale product that a purchaser has made a decision of purchase and selected in a sale product list, can process a process required for delivery, location tracing of the sale product being delivered, a result of the location tracing, etc. to be inquired of by informing a seller of announcement of the sale product for which the payment has been made, etc. such that the sale product for which the payment has been made can be delivered to the purchaser, and can manage the needed web page.

The seller terminal 200-1 to 200-n registers various sale products, services, etc. offered for sale by sellers in such an online shopping mall server 300, which is a server running the online shopping mall via the Internet 400 to relay general transactions, auctions, reverse auctions, bargaining, etc. of products, services, etc. between sellers and purchasers, and the online shopping mall server 300 provides the various registered sale products or services to the purchaser terminal 100-1 to 100-n via the Internet 400, such that purchasers can purchase needed sale products, services, and so on.

In particular, the online shopping mall server 300 performs the function of setting total amounts of shopping e-money (or Sehal money) to be provided, total numbers of months of installment payment, amounts of shopping e-money to be provided every month according to shopping e-money provision target members. At this time, the online shopping mall server 300 can select a fixed amount provision method of providing a total amount of shopping e-money to be provided in equal monthly installments, or an autonomous provision method of providing a total amount of shopping e-money to be provided in unequal monthly installments, and can differentially set the total amounts of shopping e-money to be provided according to the shopping e-money provision target members (e.g., new members and some of existing members).

Meanwhile, as the shopping e-money provision target members, members newly registered with the online shopping mall server 300 or product non-purchasing members who have not purchased a product for a certain period of time (preferably, late six months) among existing registered members may be set.

When member login input data is provided from the purchaser terminal 100-1 to 100-n, the online shopping mall server 300 performs the function of determining whether the corresponding login member is included in previously set shopping e-money provision target members, and then providing shopping e-money, which can be used to purchase products like cash, to the login member over a plurality of months according to a previously set shopping e-money provision target member when it is determined that the login member is included in the previously set shopping e-money provision target members.

When a member whose login has been accepted normally is included in the previously set shopping e-money provision target members, the online shopping mall server 300 can provide service such that current status of use of provided shopping e-money is displayed on a screen of the corresponding purchaser terminal.

The shopping mall server 300 may perform the function of monitoring shopping e-money provided to respective shopping e-money provision target members periodically or in real time and stopping provision of shopping e-money from a next month when shopping e-money provided in a first month is not used within a previously set use period (e.g., one month since the shopping e-money has been provided).

The shopping mall server 300 can provide service such that information, such as the total amounts of shopping e-money to be provided, the total numbers of months of installment payment, and the amounts of e-money to be provided every month, is stored according to the shopping e-money provision target members as a DB in the shopping e-money information DB 350.

The online shopping mall server 300 may provide service such that shopping e-money (or Sehal money) provided over a plurality of months and other shopping e-money (including Sehal money) provided before or after the shopping e-money are summed up and can be used to purchase a product like cash.

The web server 310 performs the function of interconnecting the purchaser terminal 100-1 to 100-n and the seller terminal 200-1 to 200-n with the online shopping mall server 300 via the Internet 400, and providing various web services of the online shopping mall server 300 through the particular web page.

The purchaser information DB 320 is a DB in which purchaser information, for example, purchaser identifiers (IDs), passwords, contact numbers, shopping basket information, information on products on bidding, information on auctioned-off products, information on products under bargaining, information on paid products, delivery information, information of whether or not a purchase has been determined, product information of favorite stores, etc., registered by subscribed purchasers is recorded/managed. The corresponding information can be read or updated with new purchaser information by the online shopping mall server 300.

The seller information DB 330 is a DB in which seller information (e.g., seller IDs, passwords, and contact numbers), product information (e.g., names, prices, brands, and characteristics of sale products), etc. registered by subscribed sellers is recorded/managed. The corresponding information can be read or updated with new seller information by the online shopping mall server 300.

The product information DB 340 is a DB in which information on various sale products is recorded. The corresponding information can be read or updated with new sale product information by the online shopping mall server 300.

The shopping e-money information DB 350 is a DB in which various information, such as the total amounts of shopping e-money to be provided, the total numbers of months of installment payment, and the amounts of shopping e-money to be provided every month, is recorded through the online shopping mall server 300 according to the previously set shopping e-money provision target members. The corresponding information can be read or updated with new shopping e-money information by the online shopping mall server 300.

Using a relational DB management system (RDBMS), for example, Oracle, Informix, Sybase, and DB2, or an object-oriented DB management system (OODBMS), for example, Gemston, Orion, and O2, the DBs 320 to 350 described above can be implemented according to a purpose of the present invention, and have appropriate fields to achieve their functions.

A shopping e-money management service method in electronic commerce using the Internet according to an exemplary embodiment of the present invention will be described in detail below.

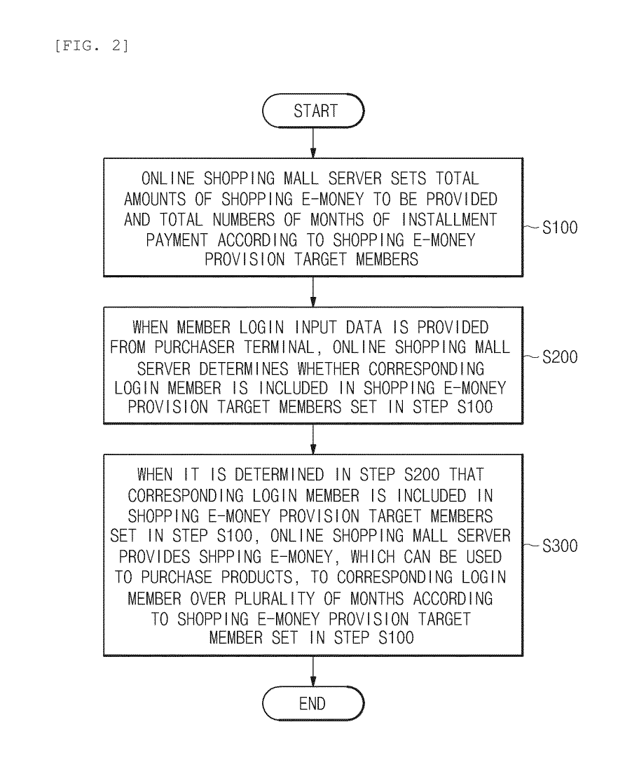

FIG. 2 is an overall flowchart illustrating a shopping e-money management service method in electronic commerce using the Internet according to an exemplary embodiment of the present invention. The shopping e-money management service method is performed by the online shopping mall server 300 unless described otherwise.

Referring to FIGS. 1 and 2, first, the online shopping mall server 300 sets total amounts of shopping e-money to be provided and total numbers of months of installment payment according to shopping e-money provision target members.

At this time, in step S100, the online shopping mall server 300 can select a fixed amount provision method of providing a total amount of shopping e-money to be provided in equal monthly installments, or an autonomous provision method of providing a total amount of shopping e-money to be provided in unequal monthly installments.

Also, in step S100, members newly registered with the online shopping mall server 300 or product non-purchasing members who have not purchased a product for a certain period of time (e.g., three months, six months, nine months, or 12 months) (preferably, six months) among existing registered members can be set as the shopping e-money provision target members.

In addition, in step S100, it is possible to differentially set the total amounts of shopping e-money to be provided according to the shopping e-money provision target members through the online shopping mall server 300. For example, it is possible to set a total of ten thousand won of shopping e-money to be provided to new members of the corresponding month by two thousand won per month for five months (2000 won×five months), and set a total of five thousand won of shopping e-money to be provided to product non-purchasing members among existing subscribed members by one thousand won per month for five months (1000 won×five months).

Next, when member login input data is provided from a purchaser terminal, the online shopping mall server 300 determines whether the corresponding login member is included in the shopping e-money provision target members set in step S100 (S200).

When it is determined in step S200 that the corresponding login member is included in the shopping e-money provision target members set in step S100, the online shopping mall server 300 provides shopping e-money, which can be used to purchase products, to the corresponding login member over a plurality of months (S300).

At this time, in step S300, when the corresponding login member is included in the shopping e-money provision target members set in step S100, the online shopping mall server 300 can provide service such that a current status of use of provided shopping e-money is displayed on a screen of the purchaser terminal.

In addition, after step S300, the online shopping mall server 300 monitors shopping e-money provided to the respective shopping e-money provision target members periodically or in real time, and can stop provision of shopping e-money from a next month when shopping e-money provided in a first month is not used within a previously set use period (e.g., one month or two months since the shopping e-money has been provided).

Further, according to the shopping e-money provision target members, the shopping mall server 300 can store and manage total amounts of shopping e-money to be provided, total numbers of months of installment payment, and amounts of e-money to be provided every month as a DB.

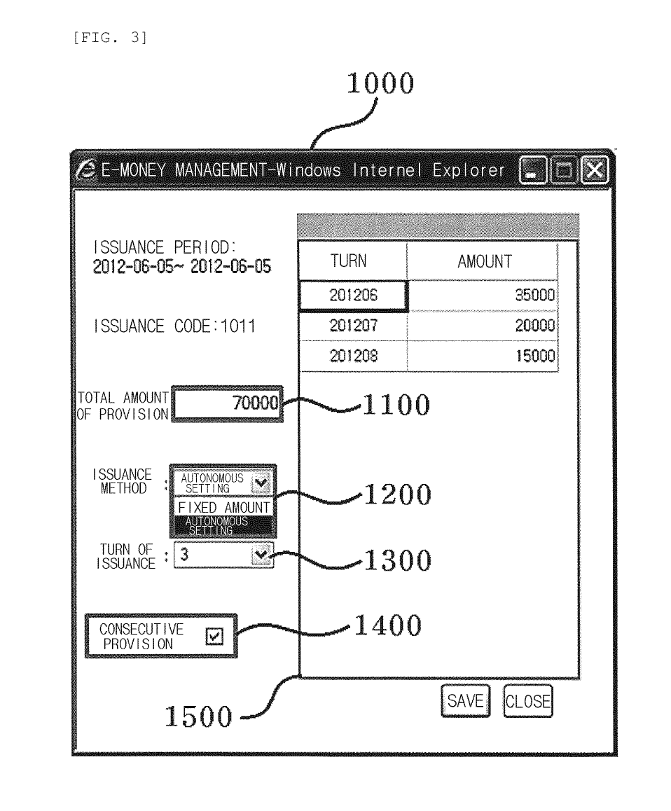

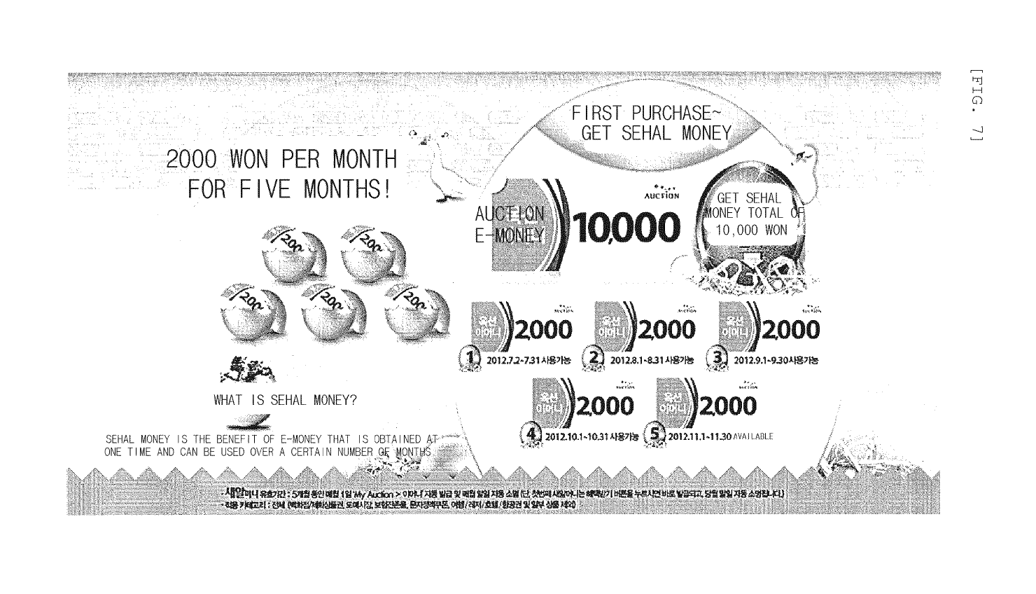

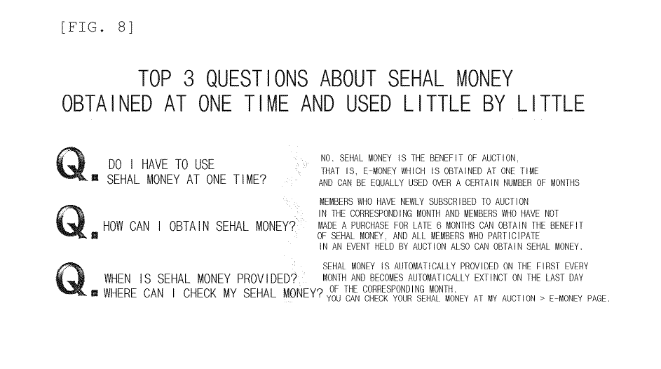

The above-described shopping e-money management service method according to the exemplary embodiment of the present invention will be described in further detail below using an example with reference to FIGS. 3 to 8.

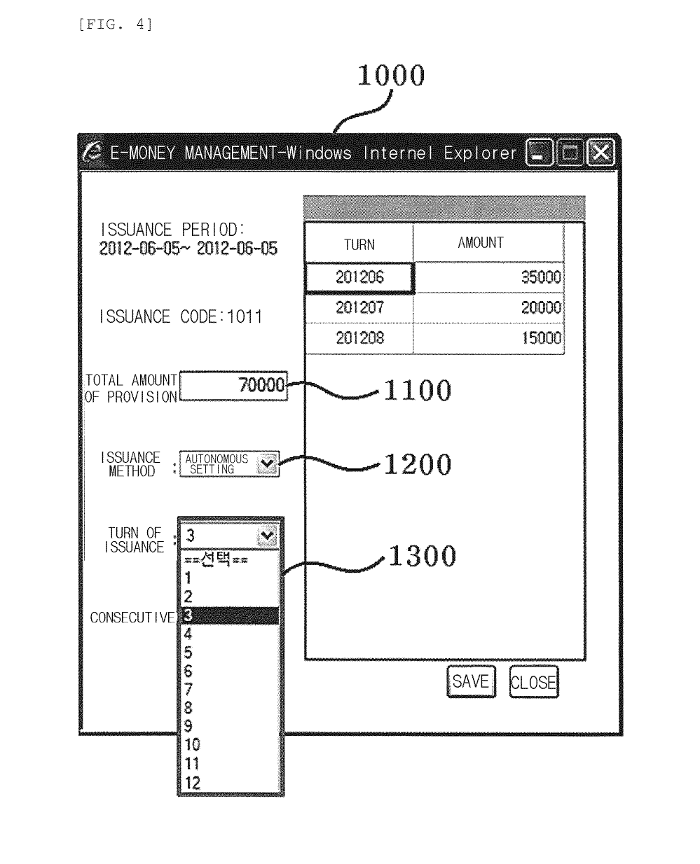

FIGS. 3 and 4 are example diagrams of a screen illustrating a shopping e-money management service method in electronic commerce using the Internet according to an exemplary embodiment of the present invention, showing screens in which standards for providing shopping e-money are set through the online shopping mall server 300.

Referring to FIGS. 3 and 4, when an arbitrary online shopping mall administrator executes a separate setting tool for setting standards for providing shopping e-money, a setting input window 1000 is displayed on a screen of a separate administrator terminal (not shown) connected with the online shopping mall server 300.

At this time, the setting input window 1000 has an input window 1100 for inputting a total amount of shopping e-money to be provided, a first selection window 1200 for setting a shopping e-money provision method (e.g., fixed amount or autonomous setting), a second selection window 1300 for setting a total number of months of installment payment, a consecutive provision check window 1400 for determining consecutive provision according to whether or not shopping e-money has been used, a display window 1500 for listing and displaying amounts of shopping e-money to be provided over a plurality of months, and so on.

Subsequently, when the administrator sets standards for providing shopping e-money through the setting input window 1000 displayed on the screen of the administrator terminal, data of the set shopping e-money provision standards is transmitted to the online shopping mall server 300, such that shopping e-money can be provided to shopping e-money provision target members over a plurality of months.

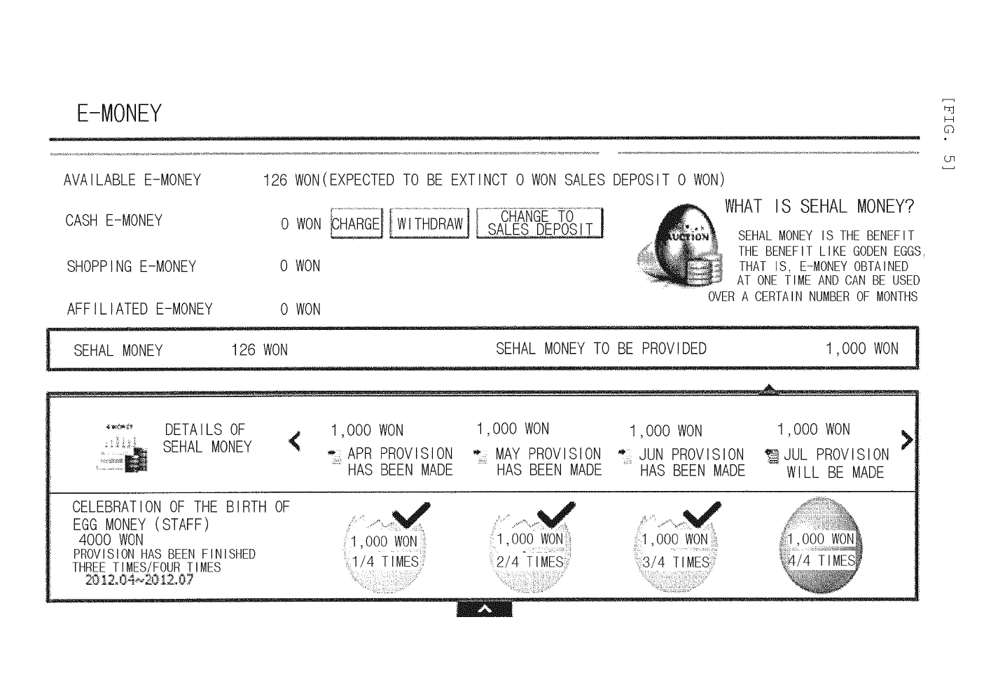

FIG. 5 is an example diagram of a screen illustrating a shopping e-money management service method in electronic commerce using the Internet according to an exemplary embodiment of the present invention. When a purchaser registered with the online shopping mall server 300 performs login through a purchaser terminal and then selects (clicks), for example, the menu “Current status of my e-money,” current status of various types of e-money, such as shopping e-money (Sehal money), cash e-money, affiliated e-money, and other shopping e-money, is displayed on a screen of the purchaser terminal as shown in FIG. 5.

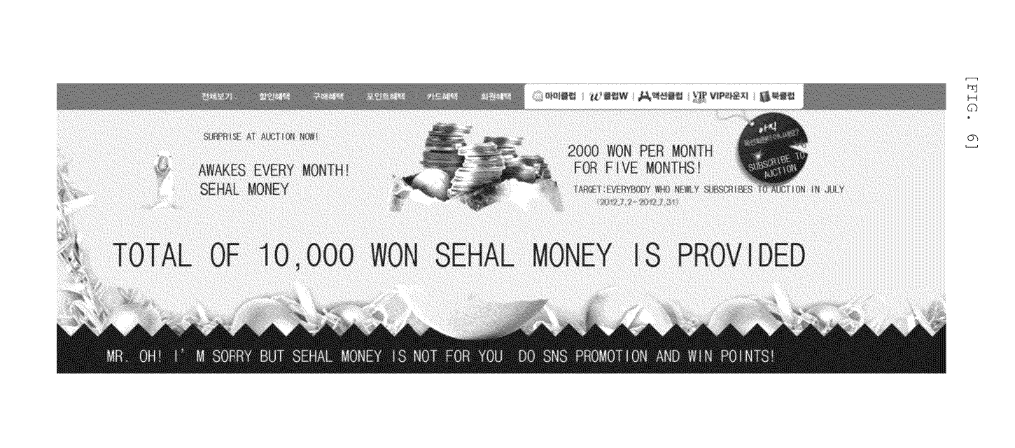

FIGS. 6 to 8 are example diagrams of a screen illustrating a shopping e-money management service method in electronic commerce using the Internet according to an exemplary embodiment of the present invention. When the web server 310 of the online shopping mall server 300 is connected through the purchaser terminal 100-1 to 100-n, an advertising screen related to shopping e-money provision can be displayed in a main page or an arbitrary sub-page as shown in FIGS. 6 to 8.

Meanwhile, a shopping e-money management service method in electronic commerce using the Internet according to an exemplary embodiment of the present invention can be implemented as computer-readable code in computer-readable recording media. The computer-readable recording media include all types of recording devices for storing data that can be read by a computer system.

For example, the computer-readable recording media include a read only memory (ROM), a random access memory (RAM), a compact disc (CD)-ROM, a magnetic tape, a hard disk, a floppy disk, a portable storage device, a non-volatile memory (flash memory), an optical data storage device, and so on.

Also, the computer-readable recording media can be distributed among computer systems connected via a computer network, and stored and executed as code readable in a distributed manner in a distributed fashion.

While the above-described exemplary embodiments of a shopping e-money management service method in electronic commerce using the Internet according to the present invention and a computer-readable recording medium storing a program for executing the same have been described with reference to certain exemplary embodiments thereof, it will be understood by those of ordinary skill in the art that various changes in form and details may be made therein without departing from the spirit and scope of the invention as defined by the appended claims.

1. A shopping e-money management service method in electronic commerce using the Internet in an electronic commerce method for relaying an online transaction when a purchaser purchases a product from an online shopping mall including a purchaser terminal connected to a shopping mall server via the Internet, the shopping e-money management service method comprising:
(a) setting, by the shopping mall server, total amounts of shopping e-money to be provided and total numbers of months of installment payment according to shopping e-money provision target members;
(b) when member login input data is provided from the purchaser terminal, determining, by the shopping mall server, whether a corresponding login member is included in the shopping e-money provision target members set in step (a); and
(c) when it is determined in step (b) that the corresponding login member is included in the shopping e-money provision target members set in step (a), providing, by the shopping mall server, shopping e-money, which can be used to purchase products, to the corresponding login member over a plurality of months according to a shopping e-money provision target member set in step (a).

2. The shopping e-money management service method of claim 1, wherein step (a) comprises selecting, by the shopping mall server, a method of providing the total amounts of shopping e-money to be provided in equal monthly installments or a method of providing the total amounts of shopping e-money to be provided in unequal monthly installments.

3. The shopping e-money management service method of claim 1, wherein step (a) comprises setting members who newly registered with the shopping mall server or product non-purchasing members who have not purchased a product for a certain period of time among existing registered members as the shopping e-money provision target members.

4. The shopping e-money management service method of claim 1, wherein
step (a) comprises differentially setting, by the shopping mall server, the total amounts of shopping e-money to be provided according to the shopping e-money provision target members.

5. The shopping e-money management service method of claim 1, wherein step © comprises, when the corresponding login member is included in the shopping e-money provision target members set in step (a), providing, by the shopping mall server, service such that current status of use of provided shopping e-money is displayed on a screen of the purchaser terminal.

6. The shopping e-money management service method of claim 1, further comprising, after step (c), monitoring, by the shopping mall server, shopping e-money provided to respective members, and stopping provision of shopping e-money when shopping e-money provided in a first month is not used.

7. The shopping e-money management service method of claim 1, further comprising, after step (c), storing and managing, by the shopping mall server, the total amounts of shopping e-money to be provided, the total numbers of months of installment payment, and amounts of shopping e-money to be provided every month according to the shopping e-money provision target members as a database (DB).

8. A computer-readable recording medium storing a program for executing the shopping e-money management service method of claim 1.
